(19) United States
(12) Patent Application Publication
(10) Pub. No.: US 2025/0179670 A1
(43) Pub. Date: Jun. 5, 2025

(54) METHOD FOR OPERATING AN ELECTROLYZER FOR THE PRODUCTION OF HYDROGEN AND OXYGEN

(71) Applicant: Robert Bosch GmbH, Stuttgart (DE)

(72) Inventors: Alexandra Hartig-Weiss, Weihenzell (DE); Dietmar Steiner, Welzheim (DE); Harald Bauer, Ehningen (DE); Juergen Hackenberg, Sachsenheim (DE); Tobias Alexander Beck, Stuttgart (DE)

(21) Appl. No.: 18/845,075

(22) PCT Filed: Feb. 6, 2023
(86) PCT No.: PCT/EP2023/052771

§ 371 Date: Sep. 9, 2024

(30) Foreign Application Priority Data
Mar. 10, 2022 (DE) 10 2022 202 395.1

(51) Int. Cl. C25B 15/02; C25B 1/04; C25B 1/50; C25B 9/19

(52) U.S. Cl. CPC C25B 15/02; C25B 1/04; C25B 1/50; C25B 9/19

(57) ABSTRACT

The invention relates to a method for operating an electrolyzer (10) for the production of hydrogen and oxygen, comprising a membrane (22), which is permeable to OH ions and separates an anode chamber (14) from a cathode chamber (16), said method comprising at least the following method steps:
a) temporary dry operation of the cathode chamber (16),
b) temporary diffusion of water molecules through the membrane (22) from the anode chamber (14) into the cathode chamber (16),
c) variation of a differential pressure (42) between the cathode chamber (16) and the anode chamber (14) by means of a restrictor valve (46), and
d) adjustment of the moistening/wetting of the cathode chamber (16) by adjusting a defined differential pressure (42).

### BACKGROUND

The invention relates to a method for operating an electrolyzer for the production of hydrogen and oxygen, comprising a membrane, which is permeable to OH ions and separates an anode chamber and a cathode chamber from each other. The invention further relates to the use of the method for operating an electrolyzer or an alkaline electrolyzer using temporary water transport through a membrane for moistening/wetting a cathode chamber.

Electrolyzers generally comprise a polymer membrane that is permeable to OH ions, as well as two electrodes on the opposite side of the membrane typically made of polymeric material. An aqueous electrolyte, for example a KOH solution, is fed into a chamber, e.g. on the oxygen producing side or anode side. An electrolyte also optionally flows through the side opposite the membrane separating the chamber and produces hydrogen. Particularly during non-stationary operation, locally occurring temperature peaks may in particular weaken the polymer membrane material, which may lead to, among other things, thinning of the membrane and consequently failure due to excessive gas diffusion or hole formation. The publication “P. Millet et al., Cell Failure Mechanisms in PEM Water Electrolyzers”, International Journal of Hydrogen Energy, vol. 37, issue 22, November 2012, pp. 17478-17487, https://doi.org/10.1016/j.ijhydene.2012.06.017 demonstrates that the cathode arranged on the hydrogen side tends toward local drying of the structures closer to the membrane, in particular when being switched off. When restarting, one failure scenario in particular is that a thermal equilibrium is not yet realized on the membrane and local temperature peaks can lead to membrane defects due to a lack of water, which has an effective cooling effect.

A dry-operated cathode also has a lower heat capacity due to the lack of water compared with a cathode that is water-flooded so that cells and stacks cool faster.

EP 2 451 992 B2 discloses an embodiment which is advantageously dry-operated on the cathode side (the hydrogen side), i.e. without the supply of a KOH electrolyte, so that, among other things, the effort for drying the hydrogen remains low. Therein, it is proposed to use an alkaline-aqueous solution starting from the dry cathode for the electrolytic production of hydrogen. The apparatus comprises the following: two half-cells, an anodic and a cathodic, separated by an anion exchange membrane, the surface of which forms a membrane electrode unit (MEA) with the cathodic half-cell contacting surface, whereby the alkaline solution is only present in the anodic half-cell.

Given a dry cathode or a dry-operated cathode chamber according to EP 2 451 992 B2, no water circulation is provided on the cathode side, i.e. on the hydrogen side. If the electrolyzer is shut down, then inhomogeneous temperatures may form on the membranes. Given that the cathode side, i.e. the cathode chamber, is filled with hydrogen gas only, the storage heat is less than in the case of a cathode chamber flooded with water or another medium. Heating upon restart of the electrolyzer can thus occur exclusively via the anode side, whereas water splitting to OH takes place on the cathode-side membrane. Given that polymer membranes with poor thermal conductivity are used in this case, local overheating for rapid start-up processes is to be expected. The reason for this lies in the varying electrical contact in individual areas where water splitting preferably occurs. As long as the water flow through the membrane for splitting the OH is not uniform, the catalyst level only works uniformly to a limited extent and may form local hotspots, which can lead to degradation in the medium term and membrane failure in the short term.

### SUMMARY

Proposed according to the invention is a method for operating an electrolyzer for the production of hydrogen and oxygen, said electrolyzer comprising a membrane, which is permeable to OH ions and separates an anode chamber and a cathode chamber from each other, the following method steps being performed:
temporary dry operation of the cathode chamber, temporary diffusion of water molecules through the membrane from the anode chamber into the cathode chamber,
variation of a differential pressure between cathode chamber and anode chamber by means of a restrictor valve, and
adjustment of the moistening/wetting of the cathode chamber by adjusting a defined differential pressure.

By means of the solution proposed according to the invention, a water inlet, also referred to as a water drag, from the anode chamber into the cathode chamber can be controlled by specifically influencing the differential pressure between the anode chamber and the cathode chamber such that the parts of the cathode chamber that are temporarily dry operated, in particular the surrounding around the membrane, are regularly sufficiently humidified. A homogeneous temperature level is thereby created in order to counteract damage to the membrane separating the anode chamber and the cathode chamber at an early stage during the service life of the membrane material.

In the method proposed according to the present invention, controlled water diffusion, preferably of desalted water, is performed in an advantageous manner through the membrane separating the anode chamber and the cathode chamber, which is preferably designed as a membrane made of polymer material.

In one advantageous embodiment of the method proposed according to the invention, fully desalted water is used for controlled water diffusion from the anode chamber into the cathode chamber, which preferably has an electrical conductivity of <0.1 μS.

Alternatively, if an alkaline electrolyzer is used in the method proposed according to the invention, a KOH solution can be used as a liquid medium instead of fully desalted water.

The method proposed according to the invention advantageously provides for a molar transport ratio of H₂O/H₂ to be increased when a pressure p_{K} in the cathode chamber is lowered. The molar transport ratio of H₂O/H₂ is referred to as the molar fraction, i.e. the diffusion movement of molar water molecules to molar hydrogen molecules.

Advantageously, in the method proposed according to the invention, the pressure _{pK} in the cathode chamber is varied by corresponding adjustment of the restrictor valve in the seconds range so that pressure fluctuations are produced.

In one advantageous embodiment of the idea underlying the invention, a variation of the pressure p_{K} in the cathode chamber and the resulting pressure peaks in the cathode chamber influence the molar transport ratio of H₂O/H₂.

In the method proposed according to the invention, the temperature in the cathode chamber can be influenced via the water transport into the cathode chamber.

The invention further relates to the use of the method for operating an electrolyzer or an alkaline electrolyzer with temporary water transport through a membrane for moistening/wetting a cathode chamber.

By means of the solution proposed according to the invention, one side, in particular the cathode side of a PEM or AEM electrolysis cell or an electrolysis stack, can only be operated temporarily dry during operation in order to keep the hydrogen drying costs and the energy expenditure required for this low. On the other hand, the solution proposed according to the invention enables the cathode side to be temporarily at least partially flooded or moistened or wetted in order to enable faster load changes, in particular when increasing hydrogen production, and also to prevent the electrolysis cell or the electrolysis stack from cooling down inhomogeneously and too quickly. In an advantageous way, the invention enables flooding or humidification to occur preferably on the cathode side such that hydrogen production can be controlled specifically, which is achieved by a targeted dosing of preferably fully desalted water with conductivities of <0.1 μS. The solution proposed according to the invention enables controllable water diffusion from the anode side to the cathode side through the membrane. Control, i.e. the control of water diffusion from the anode chamber to the cathode chamber, is achieved by variation of the pressure differential between the cathode chamber and the anode chamber.

The solution proposed according to the invention advantageously utilizes the fact that, during ion transportation through the polymer membrane separating the anode chamber and the cathode chamber, water molecules are also entrained from the anode chamber into the cathode chamber. This “water drag” is dependent on the pressure difference between the cathode side and the anode side of the electrolysis cell. By varying the differential pressure from the cathode side to the anode side, the water transport into the cathode chamber and thus the humidification or wetting of the cathode can be adjusted.

If the pressure in the cathode chamber is varied over time, then it is possible to achieve pressure peaks on the cathode side via a variation in the seconds range, which influence a molar transport ratio of H₂O/H₂.

Such rapid pressure changes can be achieved, for example, by a restrictor valve, which is electrically actuable and is advantageously located downstream of a water separator on the cathode side of the electrolysis cell or the electrolysis stack.

Furthermore, the solution proposed according to the invention can influence the temperature level on the cathode side by adjusting the water transport from the anode side to the cathode side.

### BRIEF DESCRIPTION OF THE DRAWINGS

Embodiments of the invention are described in greater detail hereinafter with reference to the drawings and the subsequent description.

Shown are:

FIG. 1 an electrolyzer having a dry operated cathode chamber and an anode chamber associated with a pump circuit, and

FIG. 2 a graph in which a molar ratio of water to hydrogen is plotted against a differential pressure between the anode chamber and cathode chamber.

### DETAILED DESCRIPTION

In the following description of the embodiments of the invention, identical or similar elements are denoted by identical reference signs, whereby a repeated description of these elements is omitted in individual cases. The drawings show the subject matter of the invention only schematically.

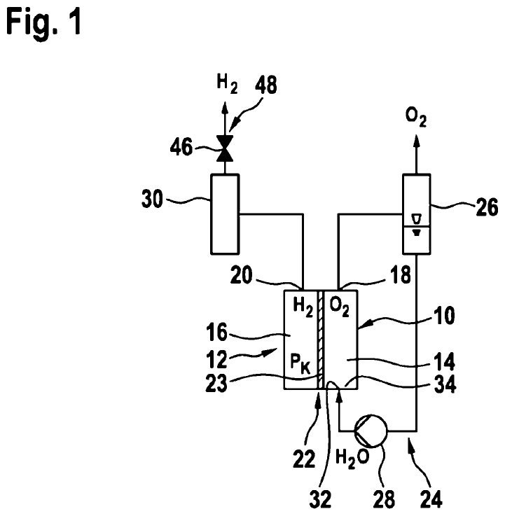

FIG. 1 shows an electrolyzer 10 with an electrolysis stack 12. The electrolyzer 10 comprises an anode chamber 14 and a cathode chamber 16 separated from each other by a membrane 22 permeable to OH ions. The latter is preferably a membrane 22 designed as a polymer membrane 23. In the cathode chamber 16, which is temporarily dry operated, gaseous hydrogen is drawn off at a hydrogen extractor 20 into a second water separator 30.

In the anode chamber 14 of the electrolyzer 10, gaseous oxygen formed in the anode chamber 14 is drawn off at an oxygen extractor 18 into a first water separator 26, which is part of a pump circuit 24. The pump circuit 24, in which the first water separator 26 is integrated, further comprises a pump 28, via which circulating water in the pump circuit 24 is fed back into the anode chamber 14 at a water supply 32. The mouth of water supply 32 is located in the bottom 34 of the anode chamber 14. The pump circuit 24 is essentially operated at a pressure level of around 1 bar in order to reduce the sealing effort required.

As further shown in the illustration in FIG. 1, a restrictor valve 46 is located downstream of a second water separator 30 on the cathode side. The restrictor valve 46 is preferably arranged in an installation position 48 at the outlet of the second water separator 30, which is located downstream of the cathode chamber 16.

In the event that the electrolyzer 10 shown in the illustration in FIG. 1 is operated with water, fully salted water is used, which preferably has a conductivity of <0.1 μS. On the other hand, there is the possibility of operating the electrolyzer 10 according to FIG. 1 as an alkaline electrolyzer 10. In this case, a KOH solution is used instead of desalted water as the circulating liquid medium in the anode chamber 14. The electrolysis stack 12 shown in FIG. 1 comprises the anode chamber 14 for the production of oxygen and the cathode chamber 16 for the production of hydrogen. The anode chamber 14 is part of the pump circuit 24 with the first water separator 26 such that oxygen can be separated and the water can be pumped back into the anode chamber 14 via the pump 28. On the cathode side, hydrogen is formed in the cathode chamber 16, which is also guided through a water separator, in this case the second water separator 30, so that the hydrogen obtained is as dry as possible. The pressure on the hydrogen side is, e.g., adjusted to 30 bar via the restrictor valve 46 in order to reduce the energetic compression effort of a downstream compressor unit in the event that the hydrogen is to be stored under pressure, which is usually the case due to the low molar weight of hydrogen.

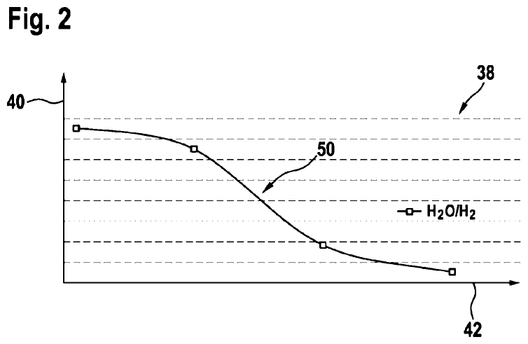

In order to improve the operation of the electrolyzer 10 proposed according to the invention, whether with desalted water or alkaline with a KOH solution, the cathode side, i.e. the cathode chamber 16, is temporarily moistened or wetted. In this respect, it is observed (see FIG. 2) at a certain operating point, given, for example, by a certain temperature as well as a certain current density, for example at 45° C. and 0.8 A/cm², water molecules are entrained from the anode chamber 14 through the membrane 22 into the cathode chamber 16 during ion transportation through the membrane 22, which is designed as a polymer membrane 23. At a certain operating point 38, as shown for example in FIG. 2 for a temperature of 45° C. and for a current density of 0.8 A/cm², the curve shown in FIG. 2 results, i.e. a decrease 50 of the molar ratio 40 of H₂O/H₂. The water diffusion from the anode chamber 14 to the cathode chamber 16 can be influenced by varying the differential pressure 42 between the cathode chamber 16 and the anode chamber 14. Depending on the level of the differential pressure 42, the water transport into the cathode chamber 16 can be influenced so that the wetting of the cathode can be adjusted. By means of the method proposed according to the invention, utilizing the water drag from the anode chamber 14 into the cathode chamber 16 can therefore achieve moistening or wetting of the components of the cathode chamber 16, in particular of the membrane 22 designed as the polymer membrane 23, at certain intervals.

This temporary moistening or wetting of the polymer membrane 23 on the cathode side can prevent local overheating during rapid start-up processes of the electrolyzer 10. By using the method proposed according to the invention, i.e. by utilizing the water diffusion from the anode chamber 14 into the cathode chamber 16, a uniformity of the temperature or a splitting of the OH ions can be achieved such that a uniform mode of operation can be achieved and local hotspots can be eliminated with regard to excess temperatures occurring, which would lead to degradation in the medium term and membrane failure in the short term.

The illustration in FIG. 2 shows how the molar ratio of H₂O/H₂ 40 or the molar fracture of water molecules to hydrogen molecules decreases 50 as the differential pressure 42 between the cathode and anode increases.

By means of the solution proposed according to the invention, in particular the restrictor valve 46 associated with the cathode chamber 16 downstream, a temporal variation of the cathode pressure pK prevailing in the cathode chamber 16 can be achieved in an advantageous manner. Given a variation within the range of seconds, pressure peaks can occur on the cathode side, which can also influence the molar ratio of H2O/H2 40 mentioned hereinabove. Such pressure variations are achieved by suitable actuation of the restrictor valve 46, which is located downstream of the second water separator 30 on the cathode side and can in particular be actuated electrically.

The invention is not limited to the exemplary embodiments described herein and the aspects highlighted thereby. Rather, within the range specified by the claims, a plurality of modifications is possible, which lie within the abilities of a skilled person.

1. A method for operating an electrolyzer (10) for the production of hydrogen and oxygen, comprising a membrane (22), which is permeable to OH ions and separates an anode chamber (14) and a cathode chamber (16) from each other, said method comprising the following method steps:
a) temporary dry operation of the cathode chamber (16),
b) temporary diffusion of water molecules through the membrane (22) from the anode chamber (14) into the cathode chamber (16),
c) variation of a differential pressure (42) between the cathode chamber (16) and the anode chamber (14) by means of a restrictor valve (46), and
d) adjustment of the moistening/wetting of the cathode chamber (16) by adjusting a defined differential pressure (42).

2. The method according to claim 1, wherein a controlled water diffusion is performed from the anode chamber (14) into the cathode chamber (16).

3. The method according to claim 1, wherein, for controlled water diffusion, fully desalted water with an electrical conductivity <0.1 μS is used.

4. The method according to claim 1, wherein a KOH solution is used for an alkaline-operated electrolyzer (10).

5. The method according to claim 1, wherein a molar transport ratio (40) of H₂O/H₂ is increased when a pressure p_{K} in the cathode chamber (16) is lowered.

6. The method according to claim 5, wherein the pressure p_{K} in the cathode chamber (16) is lowered by appropriate actuation of the restrictor valve (46) within the range of seconds.

7. The method according to claim 5, wherein a variation of the pressure p_{K} in the cathode chamber (16) and pressure peaks generated thereby in the cathode chamber (16) influence the molar transport ratio of H₂O/H₂ (40).

8. The method according to claim 1, wherein a temperature in the cathode chamber (16) is influenced via the water transport into the cathode chamber (16).

9. A method for operating an electrolyzer (10) with temporary water transport through a membrane (22) for moistening/wetting a cathode chamber (16), the method comprising:
a) performing temporary dry operation of the cathode chamber (16),
b) performing temporary diffusion of water molecules through the membrane (22) from the anode chamber (14) into the cathode chamber (16),
c) varying a differential pressure (42) between the cathode chamber (16) and the anode chamber (14) by means of a restrictor valve (46), and
d) adjusting the moistening/wetting of the cathode chamber (16) by adjusting a defined differential pressure (42).
